(19) United States
(12) Patent Application Publication
(10) Pub. No.: US 2025/0185644 A1
(43) Pub. Date: Jun. 12, 2025

(54) RODENT BARRIER AND ELECTRICAL WIRE RETENTION ELECTRICALLY INSULATING BUSHING

(71) Applicant: James M. Bradac, Hudson, WI (US)

(72) Inventor: James M. Bradac, Hudson, WI (US)

(21) Appl. No.: 18/969,906

(22) Filed: Dec. 5, 2024

Related U.S. Application Data
(60) Provisional application No. 63/608,900, filed on Dec. 12, 2023.

(51) Int. Cl. A01M 29/30; H01B 17/26

(52) U.S. Cl. CPC A01M 29/30; H01B 17/26

(57) ABSTRACT

A rodent barrier electrically insulating bushing that includes a hollow cylindrical plastic body, a plurality of axially spaced flexible annuli extending radially outward from the hollow cylindrical body, a rigid head attached to the first axial end of the hollow cylindrical body extending radially beyond the hollow cylindrical body to form a collar, and an axial orifice having a second diameter through the rigid head axially aligned with the bore extending through the hollow cylindrical body.

### BACKGROUND

Rodents are known to seek refuge inside roadway electrical poles, including traffic signal light poles, freeway lighting poles, traffic camera poles, etc. (collectively “roadway electrical poles). Sometimes, the rodents will even ascending the entire height of the roadway electrical pole to nest inside the stacked traffic signal light body atop the traffic signal light pole, the lighting fixture atop the freeway lighting pole and the traffic camera body atop the traffic camera pole (collectively “electrical device body”). These rodents frequently chew on the electrical wiring inside the roadway electrical poles and/or electrical device body, with the potential for a catastrophic failure in signaling resulting in snarled traffic and traffic accidents, failure in lighting resulting in nighttime slowed traffic and traffic accidents, and loss of visual surveillance used to monitor traffic conditions and direct prompt roadway assistance when needed.

Hence, a need exists for an inexpensive and easily installed device capable of preventing intrusion of rodents into the electrical device body, and preferably also capable of assisting in securing the electrical wiring passing through a wiring port into the electrical device body in position so as to (i) prevent gravity induced return of the wiring back through the wiring port, (ii) protect against abrasion and fraying of the insulation surrounding the electrically conductive wiring, and (iii) providing an additional layer of electrical insulation at the point where the wiring extends across the wiring port and interfaces with the electrical device body.

### BRIEF DESCRIPTION OF THE DRAWINGS

FIG. 1 is a top perspective view of one embodiment of the invention.

FIG. 2 is a bottom perspective view of the invention depicted in FIG. 1.

FIG. 3 is a top view of the invention depicted in FIG. 1.

FIG. 4 is a bottom view of the invention depicted in FIG. 1.

FIG. 5 is a side view of the invention depicted in FIG. 1.

FIG. 6 is a cross-sectional view of the invention depicted in FIG. 5 taken along line B-B.

FIG. 7 is an enlarged detail view of a portion of the invention depicted in FIG. 5 encircled by C.

FIG. 8 is an enlarged detail view of a portion of the invention depicted in FIG. 5 encircled by D.

### DETAILED DESCRIPTION OF THE INVENTION

### Including a Preferred Embodiment

Nomenclature Table

| REF. NO. | DESCRIPTION |
|---|---|
| 100 | Rodent Barrier Electrically |
| | Insulating Bushing |
| 110 | Hollow Cylindrical Body |
| 111 | First Axial End of Body |
| 112 | Second Axial End of Body |
| 119 | Axial Bore Through Body |
| 120 | Flexible Radially Extending |
| | Circumferential External Annuli |
| 120ₙ | n Sector of Annulus |
| 120₁ | First Sector of Annulus |
| 120₂ | Second Sector of Annulus |
| 120₃ | Third Sector of Annulus |
| 120₄ | Fourth Sector of Annulus |
| 128 | Gap Between Annulus Sectors |
| 130 | Head |
| 134 | Collar |
| 138 | Venting Holes Through Head |
| 139 | Axial Orifice Through Head |
| A | Axial Direction |
| R | Radial Direction |

A first aspect of the invention is a rodent barrier electrically insulating bushing 100 configured and arranged to (i) prevent intrusion of rodents into an electrical device body, (ii) protect against abrasion and fraying of the insulation surrounding the electrically conductive wiring, and (iii) provide an additional layer of electrical insulation at the point where the wiring extends across the wiring port and interfaces with the electrical device body. The bushing 100 includes a hollow cylindrical body 110 with a plurality of axially A spaced flexible annuli 120 extending radially R outward from the hollow cylindrical body 110, and is capped with a head 130 that defines a collar 134.

The hollow cylindrical body 110 has a first axial end 111 and a second axial end 112 and defines an axially A extending bore 119 having a first diameter.

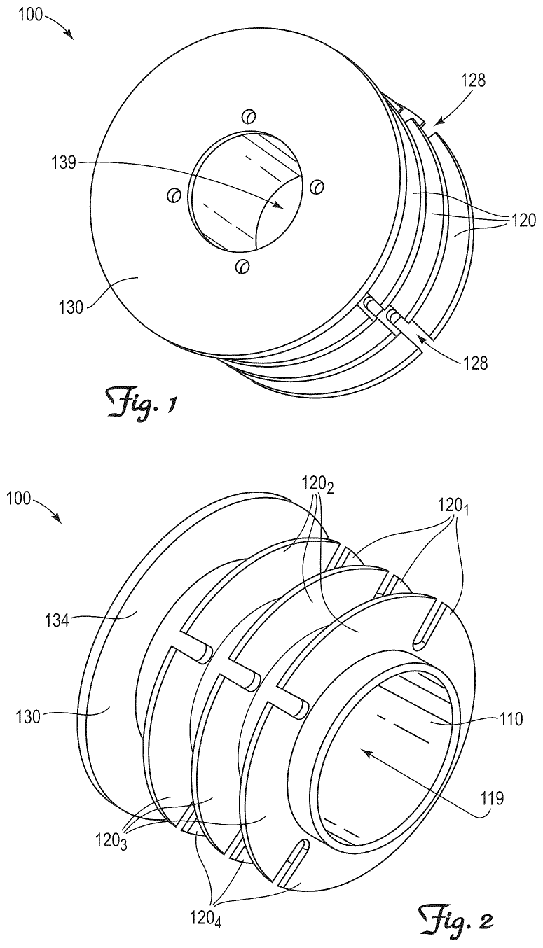

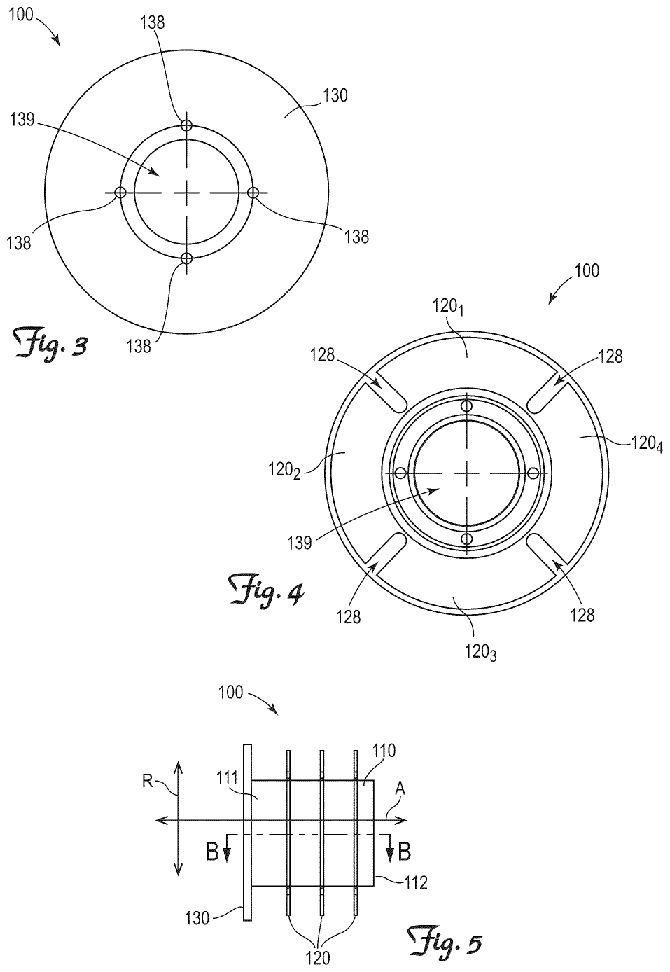

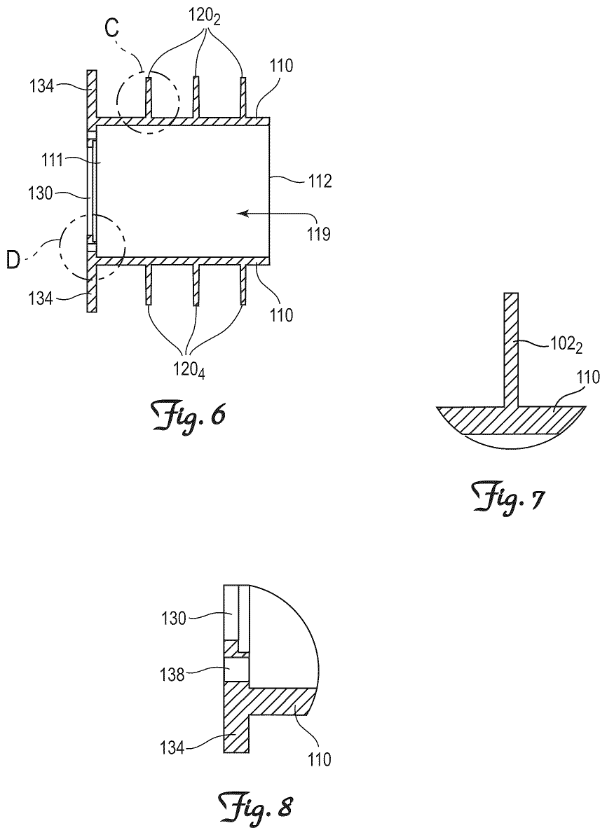

The annuli 120 extend radially R outward from the hollow cylindrical body 110 and are preferably each split into a plurality of separate axially A flexible sectors 120ₙ such as the first 120₁, second 120₂, third 120₃, and fourth 120₄ sectors as depicted in FIGS. 1, 2 and 4. Such splitting of each annuli 120 facilitates flexing of the annuli 120 during insertion and removal into a wiring port having a diameter that is larger than the outside diameter of the cylindrical body 110 but small that the outside diameter of the annuli 120. The annuli 120 are sized, shaped and configured to allow both hand insertion into and secure retention of the bushing 100 within a wiring port (not shown) having a diameter that is larger than the outside diameter of the cylindrical body 110 but small that the outside diameter of the annuli 120, while accommodating nondestructive removal of the bushing 100 from the wiring port.

The bushing 100 preferably includes between 2 and 5 annuli 120 with each annulus 120 separated from adjacent annuli 120 by an axial A distance of between 0.2 and 1 cm and each of the axially A flexible sectors 120ₙ separated by a gap 128 having a void area of less than about 0.5 cm². The distance between adjacent annuli 120 is preferably slightly larger than the thickness of the wiring port into which the bushing 100 is to be inserted to allow the annuli 120 immediately above and immediately below the wiring port to flex back into the fully extended position once the bushing 100 is inserted into its desired position. A gap 128 of less than about 0.5 cm² risks contact between adjacent sectors 120ₙ resulting in potential interference during insertion and removal of the bushing 100 into a wiring port, while a gap 128 of greater than about 0.5 cm² can result in an opening large enough to allow a rodent to pass through the bushing 100.

The head 130 is attached to the first axial end 111 of the hollow cylindrical body 110. The head 130 extends radially R beyond the hollow cylindrical body 110 to form a rigid collar 134 that functions as a stop to prevent continued insertion of the bushing 100 completely through a wiring port. Axially A extending venting holes 138 can be provided through the head 130 in fluid communication with the axial bore 119 of the body 110 to facilitate passage of water and water vapor past the bushing 100 when the axial orifice 139 through the head 130 is packed and plugged with electrical wiring such as romex cable.

An axial orifice 139 having a second diameter extends axially A through the head 130. The second diameter of the axial orifice 139 through the head 130 is preferably smaller than the first diameter of the axially A extending bore 119 through the hollow cylindrical body 110, most preferably at least 50% smaller.

The entire bushing 100 can be molded together as a single unitary piece. Suitable materials of construction include plastics and rubbers capable of providing suitable flexibility to the annuli 120.

A romex connector (not shown) can be used to clamp together electrical wiring after passage through the bushing 100 to prevent gravity induced return of the wiring back through the bushing 100.

A second aspect of the invention is a rodent-proofed electrical device body (not shown). The rodent-proofed electrical device body includes an electrical device body (not shown), a pole or mast arm extending from the pole (not shown and hereinafter collectively referenced as “pole”), electrical wiring (not shown), and a rodent barrier electrically insulating bushing 100 in accordance with the first aspect of the invention. The electrical device body is attached to the pole with a wiring port (not shown) at the junction of the electrical device body and the pole through which the electrical wiring extends. The electrical wiring extends from an internal channel in the pole through the wiring port and into the electrical device body. The ends of the electrical wiring extending through the wiring port pass through the axial bore 119 in the hollow cylindrical plastic body 110 and through the axial orifice 139 in the head 130 of the bushing 100. The bushing 100 is inserted into the wiring port with the circumferential flexible annuli 120 deflected during insertion with subsequent return to a fully extending position once insertion has been completed to secure the bushing 100 within the wiring port.

A third aspect of the invention is a method of inhibiting rodent intrusion into a electrical device body (not shown) attached to an installed pole or mast arm extending from the pole (not shown and collectively referenced as a “pole”). The method includes the steps of (i) obtaining a rodent barrier electrically insulating bushing 100 in accordance with the first aspect of the invention, (ii) inserting electric wires, extending into the electrical device body through a wiring port in the electrical device body, through the axial bore 119 in the hollow cylindrical plastic body 110 and through the axial orifice 139 in the head 130 of the bushing 100, and (iii) inserting the hollow cylindrical body 110 of the bushing 100 into the wiring port whereby the circumferential flexible annuli 120 are deflected and once fully exited returned to a fully extended position so as to secure the bushing 100 within the wiring port.

I claim:

1. A rodent barrier electrically insulating bushing, comprising:
(a) a hollow cylindrical plastic body having a first axial end and a second axial end, and defining an axially extending bore having a first diameter,
(b) a plurality of axially spaced flexible annuli extending radially outward from the hollow cylindrical body,
(c) a rigid head attached to the first axial end of the hollow cylindrical body extending radially beyond the hollow cylindrical body to form a collar, and
(d) an axial orifice having a second diameter through the rigid head axially aligned with the bore extending through the hollow cylindrical body.

2. The rodent barrier electrically insulating bushing of claim 1 wherein the second diameter is smaller than the first diameter.

3. The rodent barrier electrically insulating bushing of claim 1 wherein the second diameter is at least 50% smaller than the first diameter.

4. The rodent barrier electrically insulating bushing of claim 1 comprising between 2 and 5 annuli.

5. The rodent barrier electrically insulating bushing of claim 4 wherein the annuli are each separated from adjacent annuli by an axial distance of between 0.2 and 1 cm.

6. The rodent barrier electrically insulating bushing of claim 1 wherein each annulus is split into a plurality of separate axially flexible sectors.

7. The rodent barrier electrically insulating bushing of claim 6 wherein each annulus is split into between three and six separate axially flexible sectors, each sector separated by a gap having a void area of less than 0.5 cm².

8. A rodent-proofed electrical device body comprising:
(a) an electrical device body attached to a pole or mast arm extending from a pole,
(b) electrical wires extending from an internal channel in the pole or mast arm through an opening into the electrical device body and into electrical communication with lights or camera housed within the electrical device body, and
(c) a rodent barrier electrically insulating bushing in accordance with claim 1 circumferentially surrounding the electrical wires with the electrical wires extending through the bore of the hollow cylindrical body and through the orifice in the head, with the rodent barrier electrically insulating bushing secured by the flexible annuli and the head within the opening into the electrical device body.

9. A method of inhibiting rodent intrusion into a electrical device body attached to an installed pole or mast arm extending from the pole, comprising the steps of:
(a) obtaining a rodent barrier electrically insulating bushing in accordance with claim 1,
(b) inserting electric wires, extending into the electrical device body through a wiring port in the electrical device body, through the bore in the hollow cylindrical plastic body and through the axial orifice in the head, and
(c) inserting the hollow cylindrical body of the rodent barrier electrically insulating bushing into the wiring port whereby the circumferential flexible annuli are deflected so as to secure the rodent barrier electrically insulating bushing within the wiring port.
